(19) United States
(12) Patent Application Publication
(10) Pub. No.: US 2024/0164519 A1
(43) Pub. Date: May 23, 2024

(54) MODULAR FURNITURE CONNECTOR AND RELATED METHODS

(71) Applicant: H.M. Richards, Inc., Seffner, FL (US)

(72) Inventor: James Norman Richey, Belden, MS (US)

(21) Appl. No.: 17/990,268

(22) Filed: Nov. 18, 2022

(51) Int. Cl. A47B 87/00

(52) U.S. Cl. CPC A47B 87/007

(57) ABSTRACT

A modular furniture system including a first cushioned furniture module, a second cushioned furniture, a male connector secured to the first module, and a female connector secured to the second module. The male connector including a body and a tongue, the tongue configured to protrude from underneath the first module. The female connector including a body and an opening. The opening extending through the body and configured to protrude from underneath the second module. The modular furniture system is configured such that inserting the tongue into the opening causes the first module to compress against the second module.

### RELATED FIELDS

The present technology relates to furniture connectors, and more particularly to furniture connectors that are configured to couple pieces of modular furniture.

### BACKGROUND

Modular furniture systems often use coupling systems to secure each of the modules. Typically, these coupling systems are hard to use, non-intuitive, and fail to adequately secure the modules together.

### BRIEF SUMMARY

The terms “invention,” “the invention,” “this invention” and “the present invention” used in this patent are intended to refer broadly to all of the subject matter of this patent and the patent claims below. Statements containing these terms should be understood not to limit the subject matter described therein or to limit the meaning or scope of the patent claims below. Embodiments of the invention covered by this patent are defined by the below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Described herein are several examples of modular furniture connectors and related methods that represent significant improvements over earlier connectors and methods. The modular furniture connectors and related methods are easier to use, intuitive, and provide better securement than earlier connectors and methods.

In one example, a modular furniture system includes a first cushioned furniture module; a second cushion furniture module; a male connector configured to be secured to an underside of the first cushioned furniture module, the male connector including: a body including a top surface, a bottom surface opposing the top surface, a first end, and a second end opposing the first end; and a tongue positioned at the first end of the body, wherein the male connector is configured to be secured to the underside of the first cushioned furniture module such that at least the tongue of the male connector partially protrudes from underneath the first cushioned furniture module; and a female connector configured to be secured to an underside of the second cushioned furniture module, the female connector including: a body including a top surface, a bottom surface opposing the top surface, a first end, and a second end opposing the first end; and an opening extending through the body from the top surface to the bottom surface, the opening configured to be positioned at the first end of the body, wherein the female connector is configured to be secured to the underside of the second cushioned furniture module such that at least the first end of the body including the opening of the female connector protrudes from underneath the second cushioned furniture module; wherein the modular furniture system is configured such that inserting the tongue into the opening causes the first cushioned furniture module to compress against the second cushioned furniture module.

### BRIEF DESCRIPTION OF THE DRAWINGS

The disclosure will be readily understood by following detailed description in conjunction with the accompanying drawings, in which:

FIG. 1 is a perspective view of an example of a male connector in accordance with the present disclosure.

FIG. 2 is a top view of the male connector of FIG. 1.

FIG. 3 is a bottom view of the male connector of FIG. 1.

FIG. 4 is a first side view of the male connector of FIG. 1.

FIG. 5 is a second side view of the male connector of FIG. 1.

FIG. 6 is a front view of the male connector of FIG. 1.

FIG. 7 is a back view of the male connector of FIG. 1.

FIG. 8 is a perspective view of an example of a female connector in accordance with the present disclosure.

FIG. 9 is a top view of the female connector of FIG. 8.

FIG. 10 is a bottom view of the female connector of FIG. 8.

FIG. 11 is a first side view of the female connector of FIG. 8.

FIG. 12 is a second side view of the female connector of FIG. 8.

FIG. 13 is a front view of the female connector of FIG. 8.

FIG. 14 is a back view of the female connector of FIG. 8.

FIG. 15 is a perspective view of the male connector of FIG. 1 and the female connector of FIG. 8 mated together in accordance with the present disclosure.

FIG. 16 is a top view of the mated male connector and female connector of FIG. 15.

FIG. 17 is a bottom view of the mated male connector and female connector of FIG. 15.

FIG. 18 is a first side view of the mated male connector and female connector of FIG. 15.

FIG. 19 is a second side view of the mated male connector and female connector of FIG. 15.

FIG. 20 is a front view of the mated male connector and female connector of FIG. 15.

FIG. 21 is a back view of the mated male connector and female connector of FIG. 15.

FIG. 22 is a perspective view of a second example of a male connector in accordance with the present disclosure.

FIG. 23 is a top view of the male connector of FIG. 22.

FIG. 24 is a bottom view of the male connector of FIG. 22.

FIG. 25 is a first side view of the male connector of FIG. 22.

FIG. 26 is a second side view of the male connector of FIG. 22.

FIG. 27 is a front view of the male connector of FIG. 22.

FIG. 28 is a back view of the male connector of FIG. 22.

FIG. 29 is a perspective view of a second example of a female connector in accordance with the present disclosure.

FIG. 30 is a top view of the female connector of FIG. 29.

FIG. 31 is bottom view of the female connector of FIG. 29.

FIG. 32 is a first side view of the female connector of FIG. 29.

FIG. 33 is a second side view of the female connector of FIG. 29.

FIG. 34 is a front view of the female connector of FIG. 29.

FIG. 35 is a back view of the female connector of FIG. 30.

FIG. 36 is a perspective view of the male connector of FIG. 22. And the female connector of FIG. 29 mated together in accordance with the present disclosure.

FIG. 37 is a top view of the mated male connector and female connector of FIG. 36.

FIG. 38 is a bottom view of the mated male connector and female connector of FIG. 36.

FIG. 39 is a first side view of the mated male connector and female connector of FIG. 36.

FIG. 40 is a second side view of the mated male connector and female connector of FIG. 36.

FIG. 41 is a front view of the mated male connector and female connector of FIG. 36.

FIG. 42 is a back view of the mated male connector and female connector of FIG. 36.

FIG. 43 is a perspective view of the male connector of FIG. 1 coupled to a first furniture module and the female connector of FIG. 8 coupled to a second furniture module in accordance with the present disclosure.

FIG. 44 is a perspective view of the male connector of FIG. 43 coupled with the female connector of FIG. 43 in accordance with the present disclosure.

### DETAILED DESCRIPTION

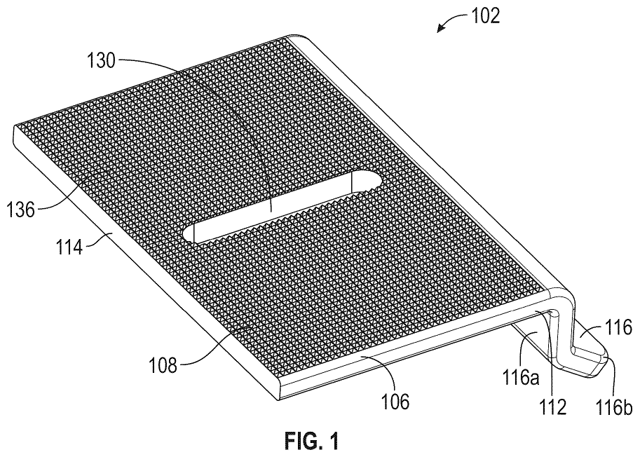

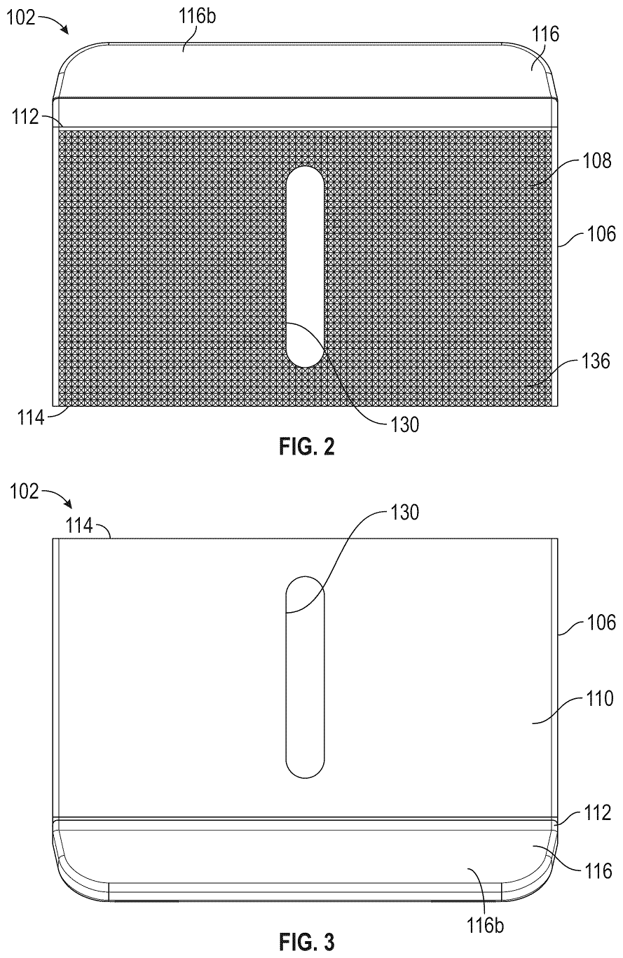

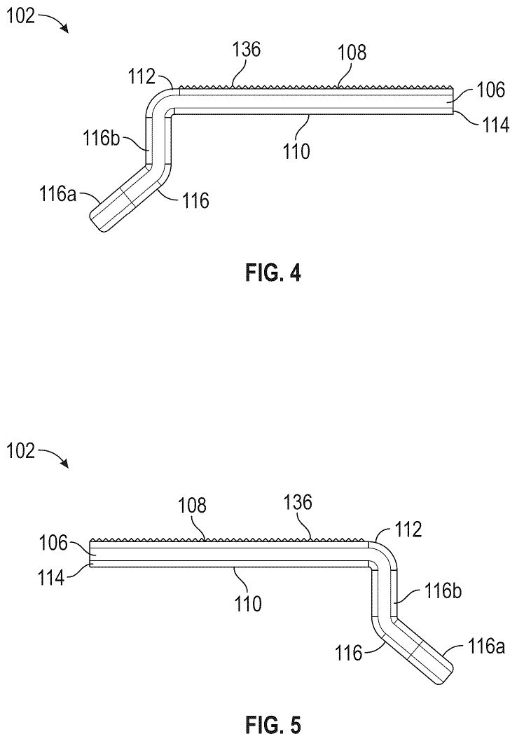

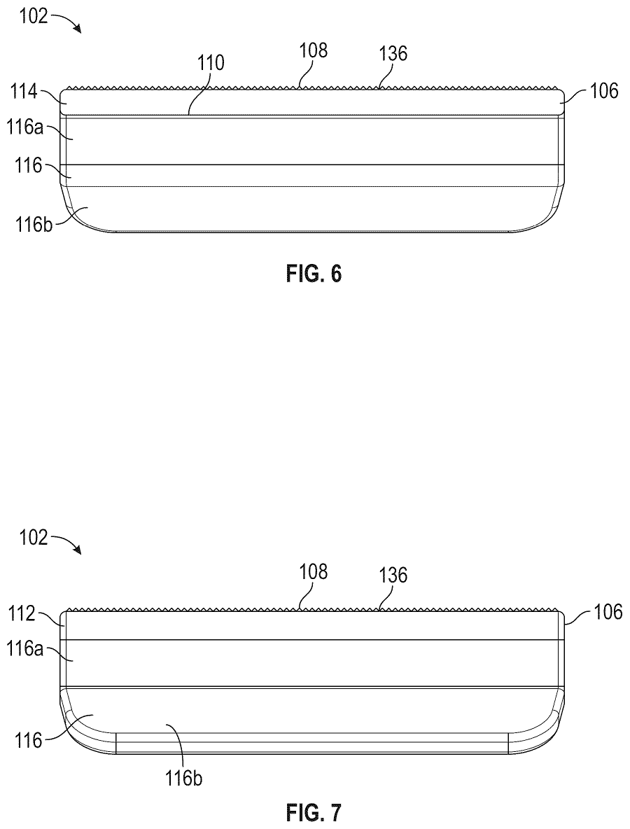

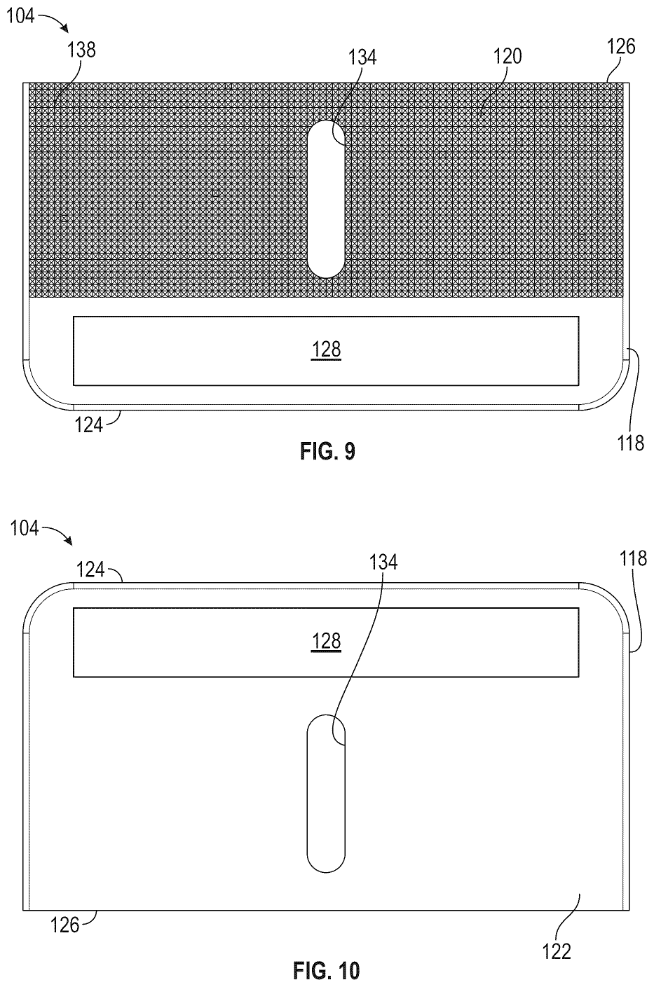

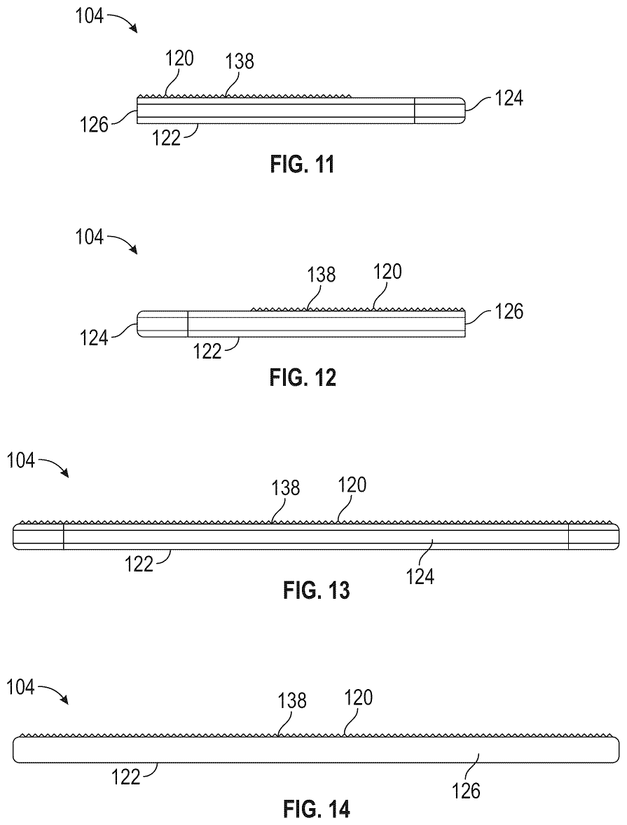

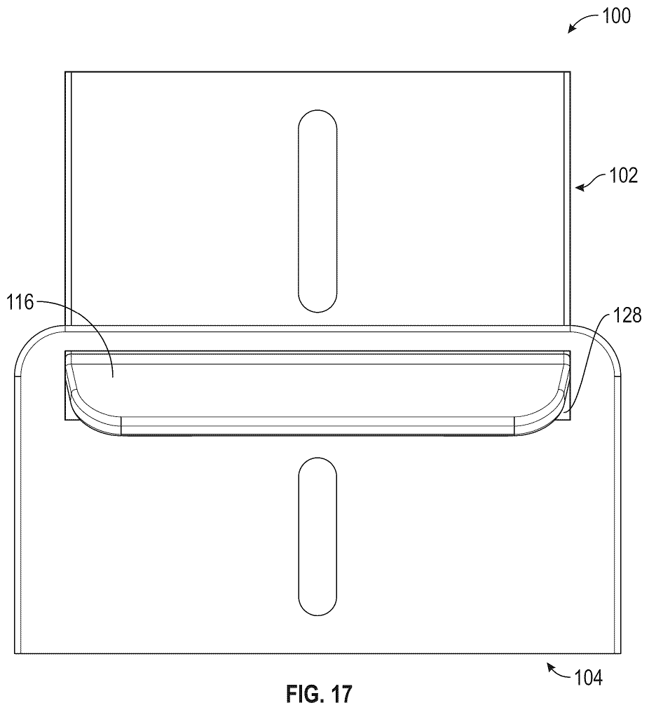

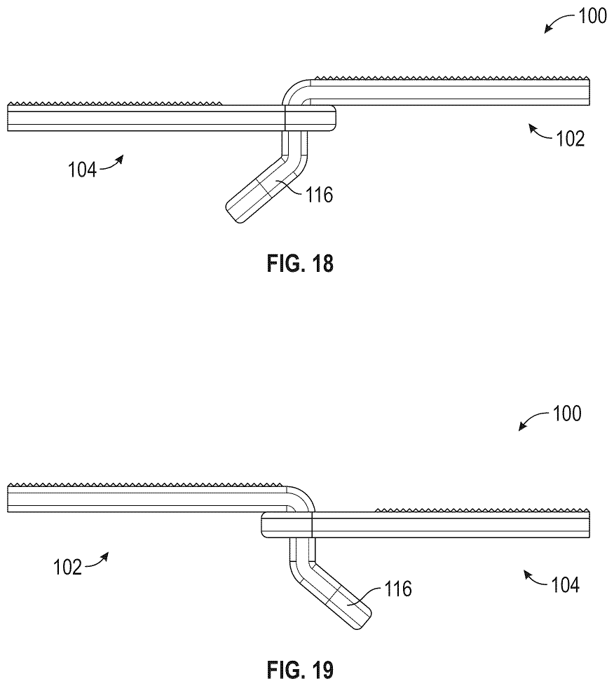

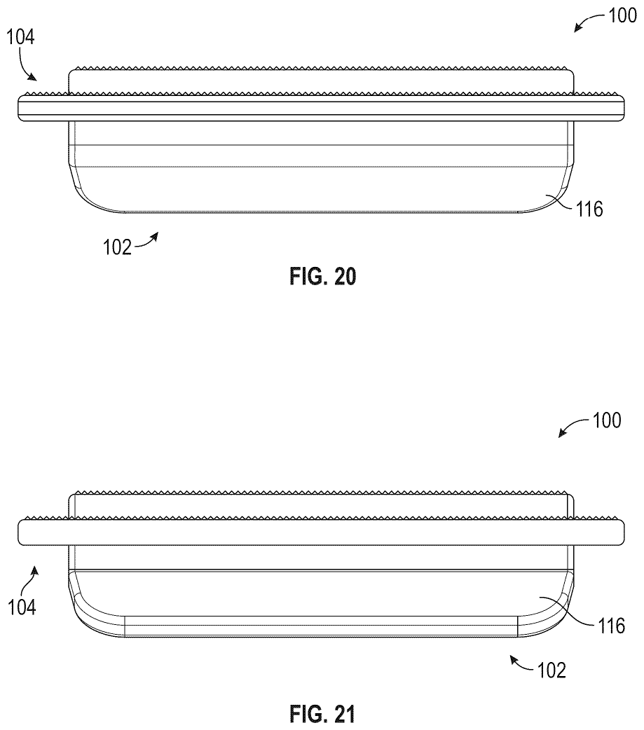

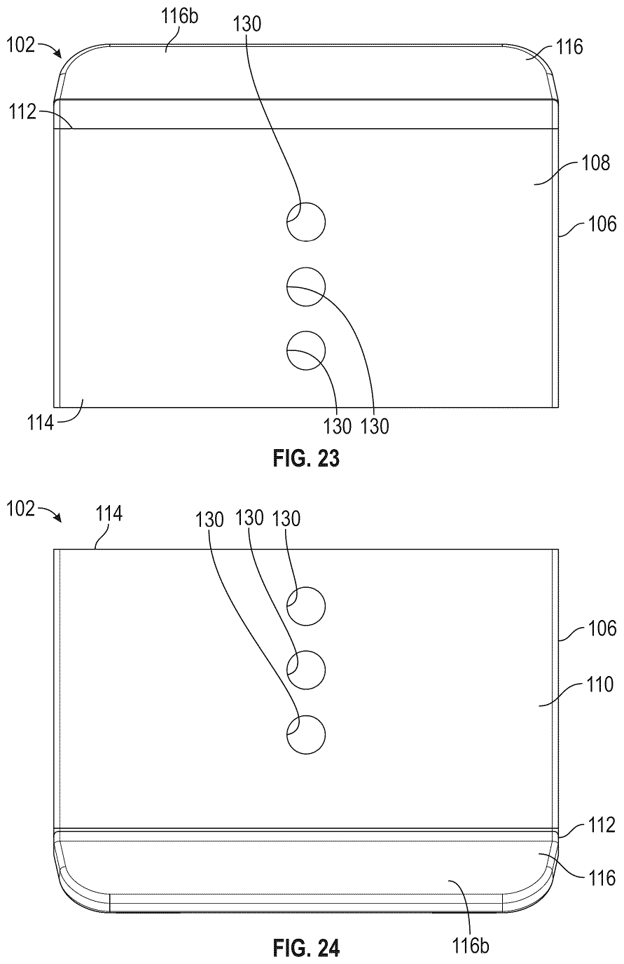

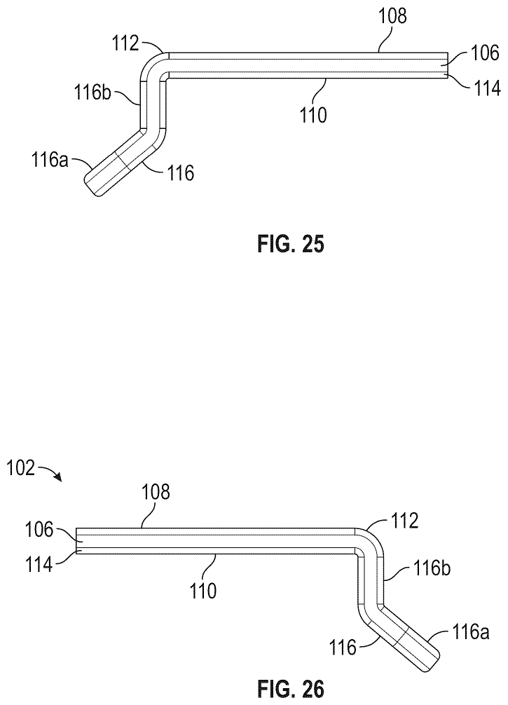

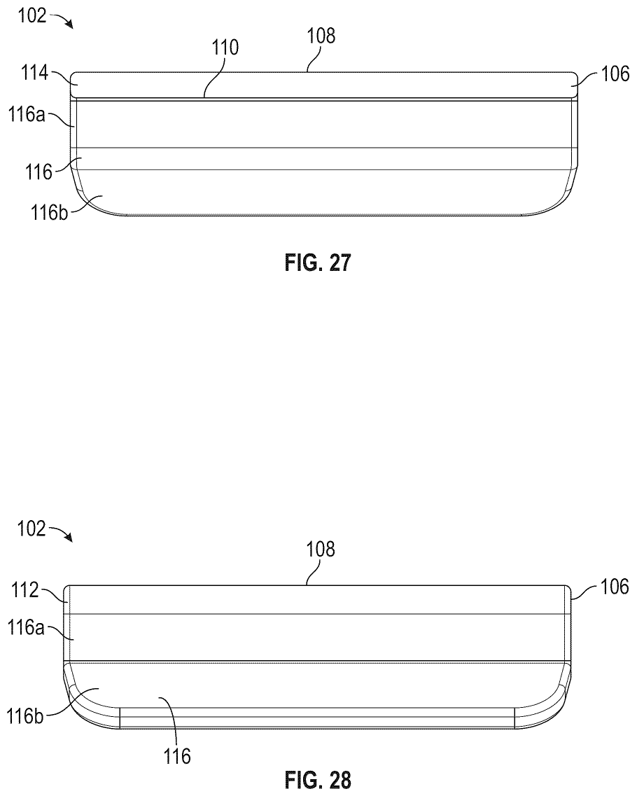

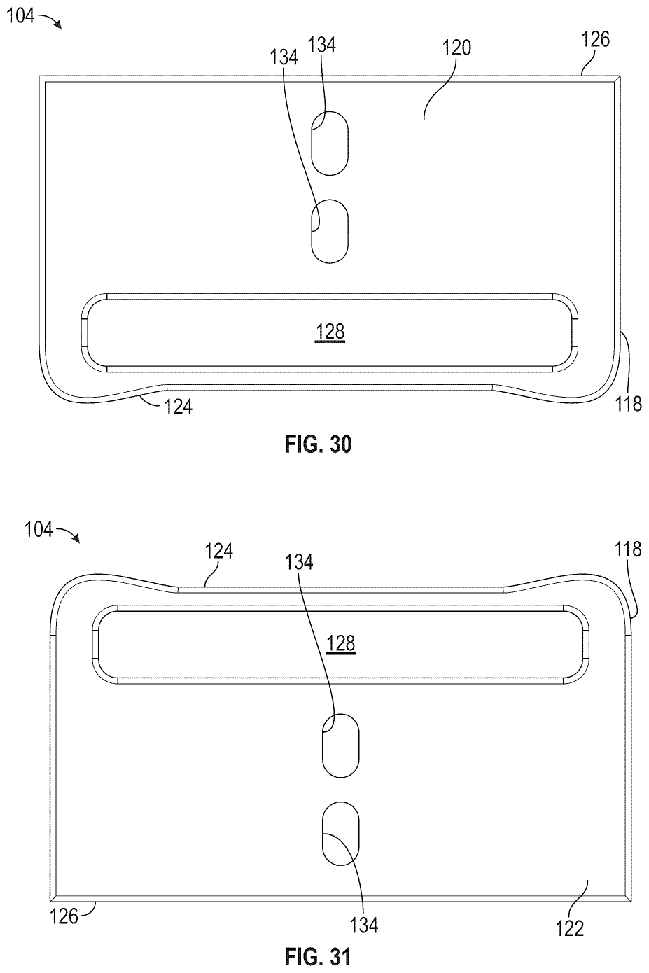

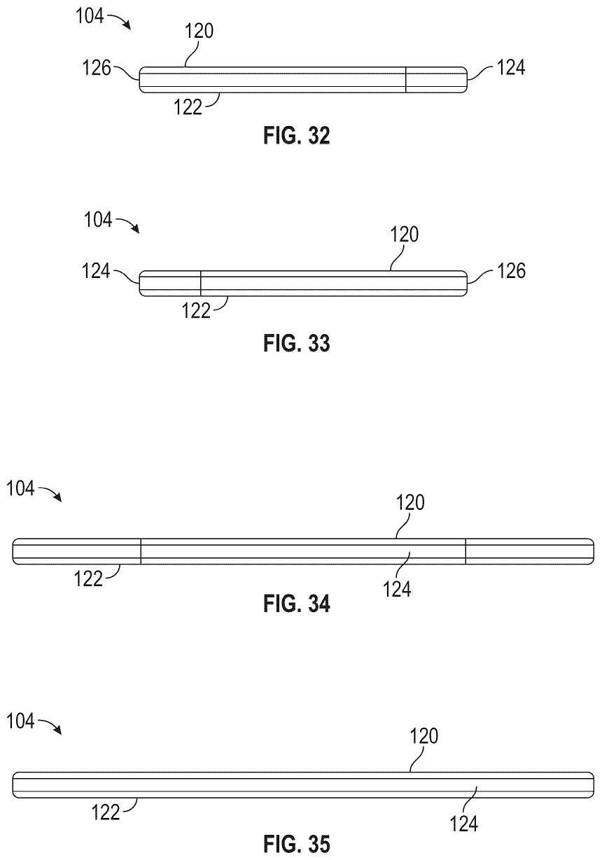

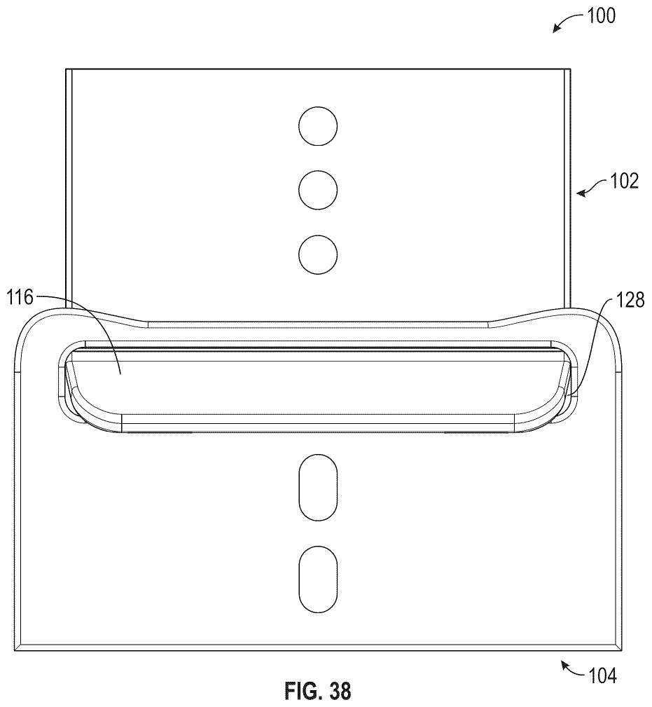

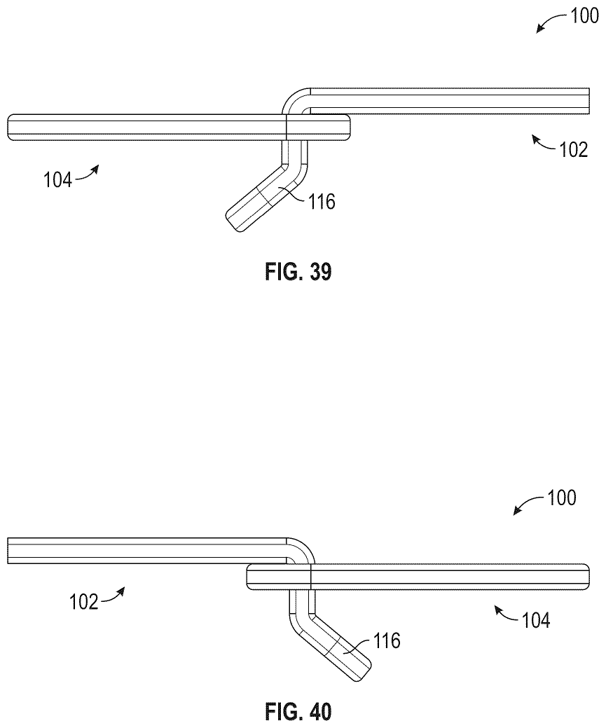

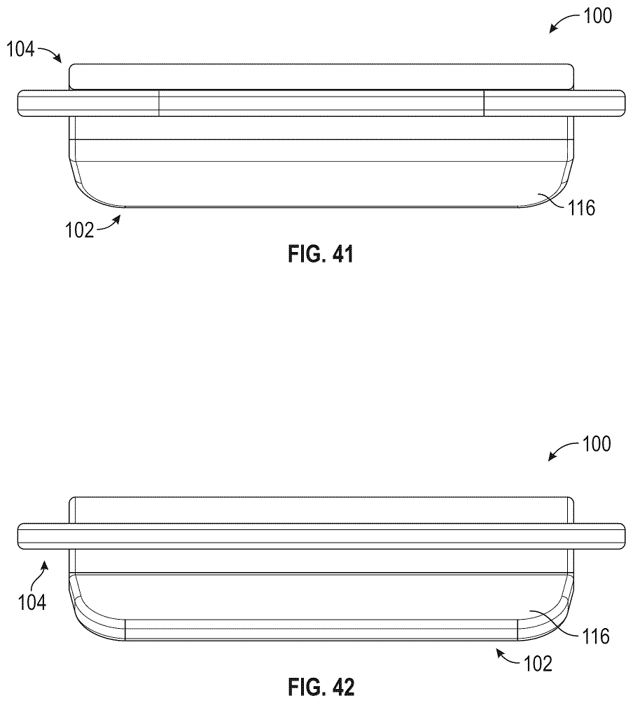

FIGS. 1-44 show examples of an apparatus 100 for coupling modular furniture 200 having a first cushioned furniture module 202 and a second cushioned furniture module 204. The apparatus 100 includes a male connector 102 configured to be coupled to a first cushioned furniture module 202 and a female connector 104 configured to be coupled to a second cushioned furniture module 204. Generally, the male connector 102 is configured to mate with the female connector 104 as to secure the first cushioned furniture module 202 and the second cushioned furniture module 204 together by compressing the first cushioned furniture module 202 against the second cushioned furniture module 204.

FIGS. 1-42 show a variety of views of the male connector 102 which generally includes a body 106 and a tongue 116 and is configured to be coupled to an underside 202a of the first cushioned furniture module 202. The body 106 includes a top surface 108, a bottom surface 110 opposing the top surface 108, a first end 112, and a second end 114. The body 106 is depicted as having a generally square or rectangular shape, however, this is merely exemplary, and a variety of other shapes are envisioned within the scope of this disclosure. The tongue 116 may be positioned at the first end 112 of the body 106. The tongue 116 includes a first portion 116a that extends substantially perpendicularly from the bottom surface 110 of the body 106 and a second portion 116b which extends from and slopes away from the first portion 116a and the bottom surface 110. Additionally, the second portion 116b of the tongue 116 may be configured to extend at an obtuse angle relative to the underside 202a of the first cushioned furniture module 202 when the male connector 102 is secured to the underside 202a of the first cushioned furniture module 202. The male connector 102 may be constructed of a variety of materials typically used in furniture or furniture accessories, such as metals, plastics, etc.

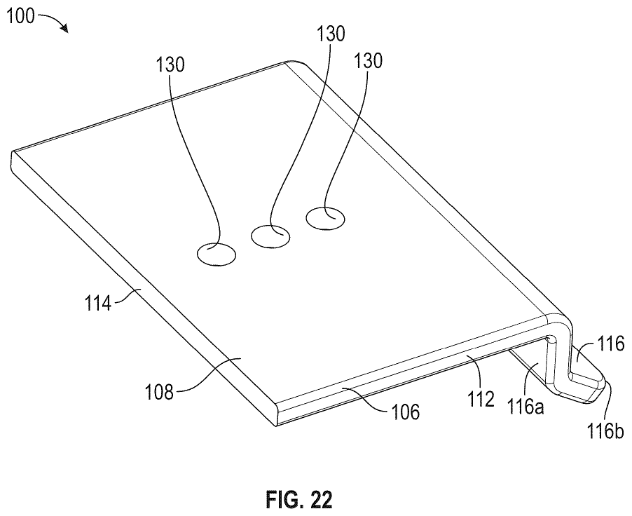

To couple the male connector 102 to the underside 202a of the first cushioned furniture module 202, a coupling opening 130 configured to accept a fastener 132 may extend through the body 106 of the male connector 102 from the top surface 108 to the bottom surface 110. In some embodiments and as shown in FIGS. 1-7, the coupling opening 130 may be an elongated opening allowing for the male connector 102 to be adjusted relative to the underside 202a of the first cushioned furniture module 202, resulting in the male connector 102 being compatible with a variety of different shaped and dimensioned cushioned furniture modules. Alternatively, as shown in FIGS. 22-28, a plurality of coupling openings 132 may be used. The plurality of coupling openings 132 may keep the male connector 102 from loosening relative to the first cushioned furniture module 202 if the fastener 132 is not properly tightened. Additionally, the coupling openings 132 may be used to adjust amount of compression between the male connector 102 and the female connector 104 once they are coupled. In order to couple the male connector 102 to the underside 202a of the first cushioned furniture module 202, the top surface 108 of the male connector 102 is positioned at the underside 202a of the first cushioned furniture module 202 and the coupling opening 130 is aligned with an aperture (not shown) of the first cushioned furniture module 202. The fastener 132 may then be inserted through the coupling opening 130 from the bottom surface 110 of the male connector 102 into the aperture of the first cushioned furniture module 202 and tightened as to secure the male connector 102 to the first cushioned furniture module 202. The fasteners 132 and the aperture of the first cushioned furniture module 202 may be threaded so that the fastener 132 and aperture may mate as to secure the male connector 102 to the first cushioned furniture module 202.

In some embodiments, as shown in FIGS. 1-7, the male connector 102 may include a textured surface 136 as to increase the amount of friction between the top surface 108 and the underside 202a of the first cushioned furniture module 202. The textured surface 136 may be positioned at and extend at least partially across the top surface 108 of the body 106. The static friction created by the textured surface 136 keeps the male connector 102 still relative to the first cushioned furniture module 202, reducing the risk of or preventing the male connector 102 of rotating relative to the underside 202a of the first cushioned furniture module 202. The textured surface 136 may be a separate component that may be applied to the top surface 108 using adhesives or other methods known in the art, or, alternatively, the textured surface 136 may be manufactured coincidently with the male connector 102 as to form a unitary body. The textured surface 136 may include ridges, knobs, grooves, or other friction increasing structures. The textured surface 136 is merely optional and embodiments of the male connector 102 without a textured surface are within the scope of this disclosure.

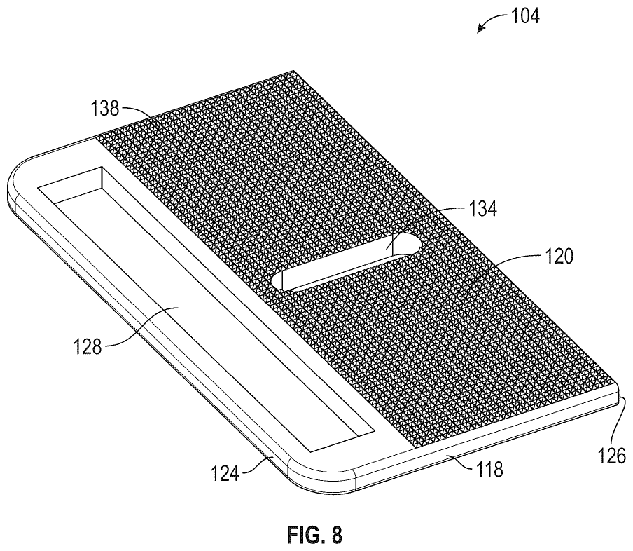

FIGS. 8-14 show a variety of views of the female connector 104 which generally a body 118 and an opening 128. The body 118 of the female connector 104 includes a top surface 120, a bottom surface 122 opposing the top surface 120, a first end 124, and a second end 126. The body 106 is depicted as having a generally square or rectangular shape, however, this is merely exemplary, and a variety of other shapes are envisioned within the scope of this disclosure. The opening 128 is positioned towards the first end 124 of the body 118 and extends through the body 118 from the top surface 120 to the bottom surface 122. The opening 128 is configured as to protrude from underneath the second cushioned furniture module 204 when the female connector 104 is secured to the underside 204a of the second cushioned furniture module 204. Similarly to the male connector 102, the female connector 104 may be constructed of a variety of materials typically used in furniture or furniture accessories, such as metals, plastics, etc.

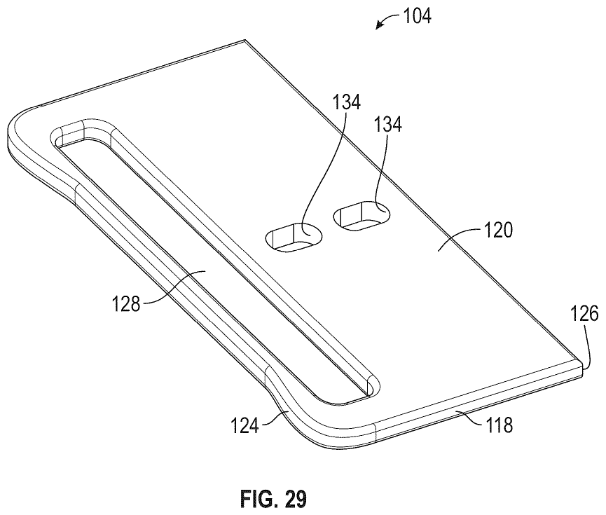

Similarly to the male connector 102 described above, the female connector 104 may be coupled to the underside 204a of the second cushioned furniture module 204, a coupling opening 134 configured to accept a fastener 132 may extend through the body 118 of the female connector 104 from the top surface 120 to the bottom surface 122. As shown in FIGS. 8-14, the coupling opening 134 may be an elongated opening allowing for the female connector 104 to be adjusted relative to the underside 204a of the second cushioned furniture module 204, resulting in the female connector 104 being compatible with a variety of different shaped and dimensioned cushioned furniture modules. Alternatively, as shown in FIGS. 29-35, a plurality of coupling openings 134 may be used. The plurality of coupling openings 134 may keep the female connector 104 from loosening relative to the second cushioned furniture module 204 if the fastener 132 is not properly tightened. Additionally, the coupling openings 134 may be used to adjust amount of compression between the female connector 104 and the male connector 102 once they are coupled. In order to couple the female connector 102 to the underside 204a of the second cushioned furniture module 204, the top surface 120 of the female connector 104 is positioned at the underside 204a of the second cushioned furniture module 204 and the coupling opening 134 is aligned with an aperture (not shown) of the second cushioned furniture module 204. The fastener 132 may then be inserted through the coupling opening 134 from the bottom surface 122 of the female connector 104 into the aperture of the second cushioned furniture module 204 and tightened as to secure the female connector 104 to the second cushioned furniture module 204. The fasteners 132 and the aperture of the second cushioned furniture module 204 may be threaded so that the fastener 132 and aperture may mate as to secure the female connector 104 to the second cushioned furniture module 204.

In some embodiments, as shown in FIGS. 8-14, the female connector 104 may include a textured surface 138 as to increase the amount of friction between the top surface 120 and the underside 204a of the second cushioned furniture module 204. The textured surface 138 may be positioned at and extend at least partially across the top surface 120 of the body 118. The resulting static friction created by the textured surface 138 keep the female connector 104 still relative to the second cushioned furniture module 204, reducing the risk of or preventing the risk of or preventing the female connector 104 of rotating relative to the underside 204a of the second cushioned furniture module 204. The textured surface 138 may be a separate component that may be applied to the top surface 120 using adhesives or other methods known in the art, or, alternatively, the textured surface 138 may be manufactured coincidently with the male connector 102 as to form a unitary body. The textured surface 138 may include ridges, knobs, grooves, or other friction increasing structures. The textured surface 136 is merely optional and embodiments of the female connector 104 without a textured surface are within the scope of this disclosure.

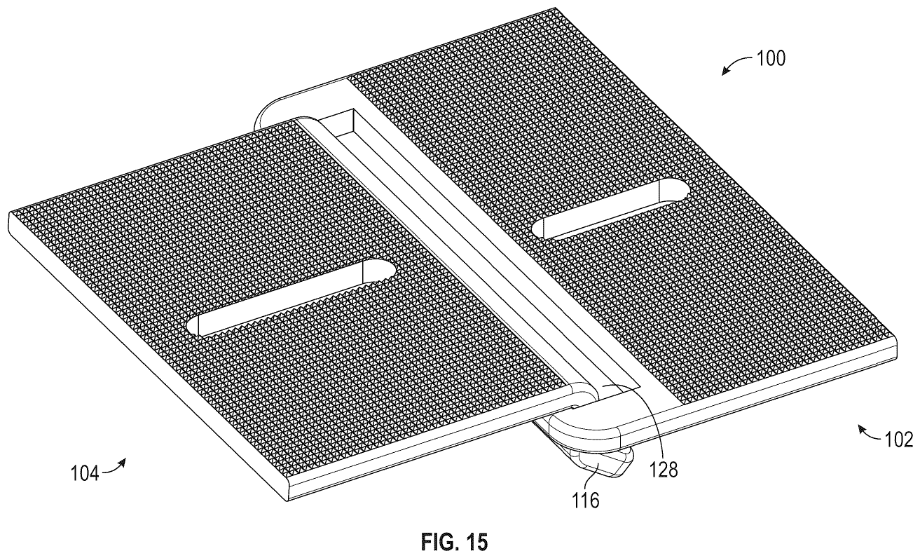

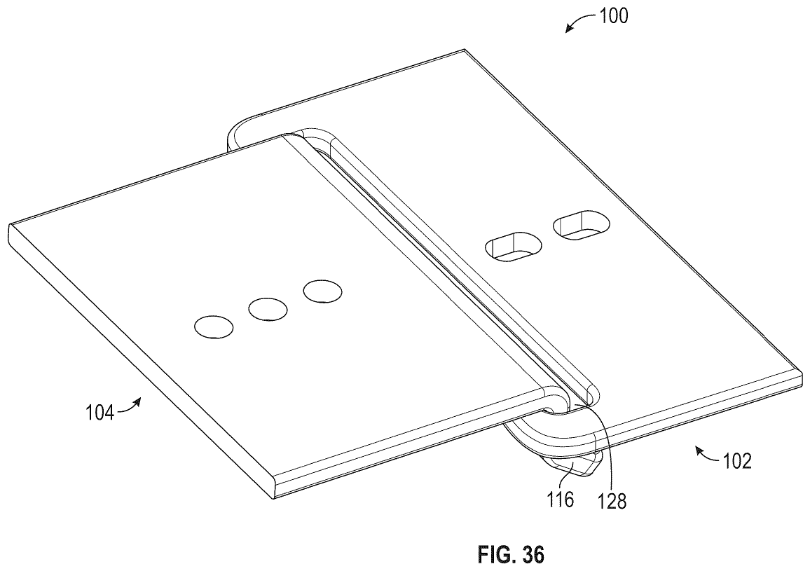

FIGS. 15-21 and FIGS. 36-42 shows a variety of views of the apparatus 100. In particular, FIGS. 15-21 depict the male connector 102 of FIGS. 1-7 mated with the female connector 104 of FIGS. 8-14, while FIGS. 36-42 depict the male connector 102 of FIGS. 22-28 mated with the female connector 104 of FIGS. 29-35. In each example, the tongue 116 of the male connector 102 is positioned within the opening 128 of the female connector 104. The apparatus 100 is configured such that inserting the tongue 116 of the male connector 102 into the opening 128 of the female connector 104 causes the first cushioned furniture module 202 to compress against the second cushioned furniture module 204. To explain, while being inserted the tongue 116 is configured as to slide across an edge 128a of the opening 128 of the body 118 of the female connector 104 as to move the first cushioned furniture module 202 closer to the second cushioned furniture module 204 as to compress the first cushioned furniture module 202 against the second cushioned furniture module 204. Once inserted, the tongue 116 is configured as to sit within the opening 128 of the body 118 of the female connector 104 as to maintain the position of the first cushioned furniture module 202 relative to the second cushioned furniture module 204, subsequently, maintaining the compression between the first module 202 and the second module 204. The compression between the modules 202, 204 creates a secure connection that pulls the modules 202, 204 together as to ensure no movement of the modules 202, 204 relative to one another. As noted above, the apparatus 100 may be adjusted using the coupling openings 132, 134 of the connectors 102, 104 as to change the amount of compression between the modules 202, 204, for example, a higher amount of compression results in a greater amount of pressure between the two modules 202, 204, resulting in a tighter connection. In some embodiments, the design of the apparatus 100 allows for the first cushioned furniture module 202 and the second cushioned furniture module 204 to be secured together using only a singular male connector 102 and a singular positioned female connector 104.

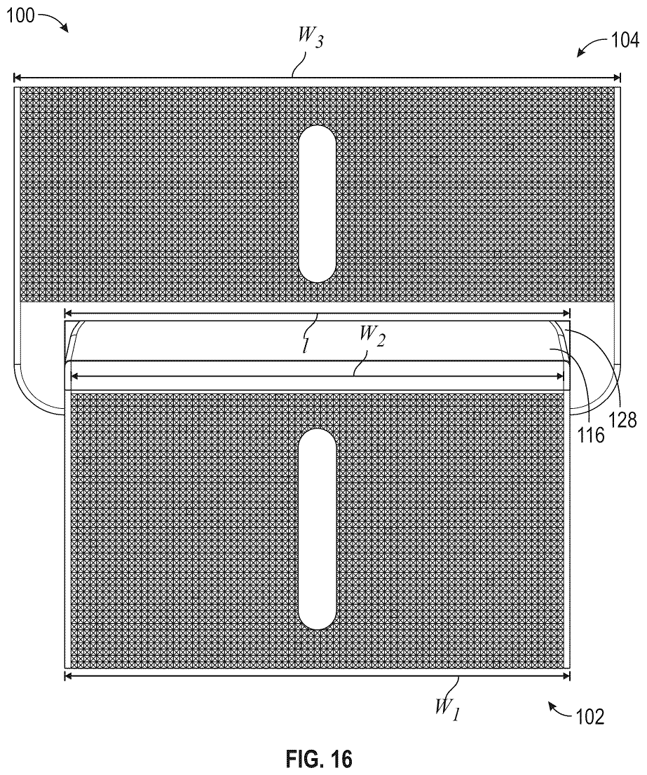

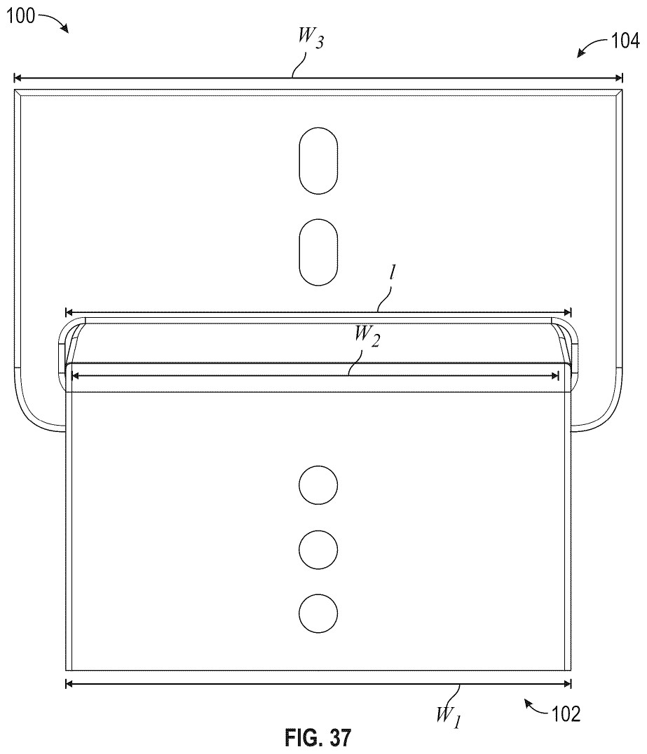

Referring to FIG. 16 and FIG. 37, which depicts a top view of the apparatus 100, exemplary dimensions of the male connector 102 and female connector 104 are shown. The male connector 102 includes a width W₁ which may fall in the range between 4 inches and 6 inches. The tongue 116, which extends from the male connector 102, includes a width W₂ which, as shown, may be the same as the width W₁ of the male connector 102, however, there are some applications wherein the width W₂ of the tongue 116 may differ from the male connector 102, with the width W₂ being in the range of 4 inches and 6 inches. The female connector 104 includes a width W₃ that may range between 5 inches and 7 inches. The opening 128 of the female connector 104 may be dimensioned as to have a length/between 4 inches and 6 inches that is sized to be greater than the width of the tongue 116 as to allow for the tongue 116 to be inserted within the opening 128. In embodiments wherein the width W₁ of the male connector 102 is substantially similar to the width W₂ of the tongue 116, the length/of the opening 128 may be sized to be greater than the width W₁ of the male connector 102. Such dimensions allow for the male connector 102 and the female connector 104 to mate as to create the required compression as to secure the first cushioned furniture module 202 and the second cushioned furniture module 204 together. The dimensions described above are merely exemplary and are not meant to be limiting, a variety of additional dimensions are envisioned with the scope of this disclosure.

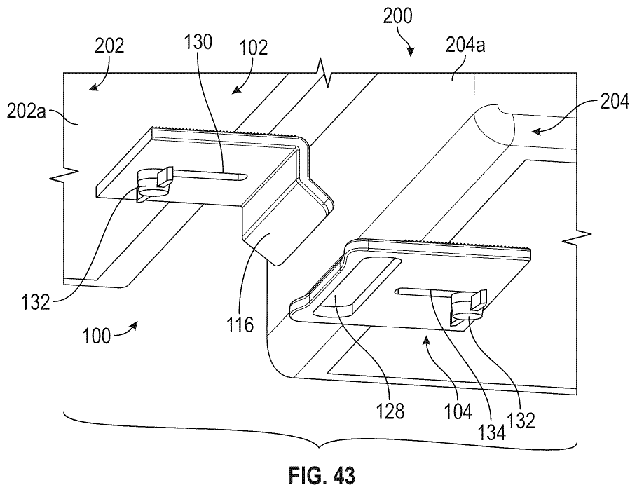

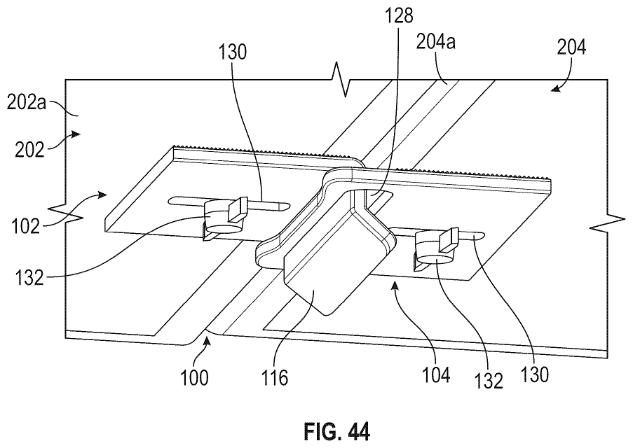

A method for coupling the first cushioned furniture module 202 and the second cushioned furniture module 204 is depicted in FIGS. 43 and 44 and described below. The method includes securing the male connector 102 to the underside 202a of the first cushioned furniture module 202. As described above, the male connector 102 includes a body 106 and a tongue 116. The body 106 includes the top surface 108, the bottom surface 110 opposing the top surface 108, the first end 112, and the second end 114 opposing the first end 112. The tongue 116 is positioned at the first end 112 of the body 106 and is configured so that when the male connector 102 is secured to the first cushioned furniture module 202 the tongue 116 partially protrudes from underneath the first cushioned furniture module 202. In some embodiments, at least a portion of the tongue 116, in some embodiments the second portion 116b, extends at an obtuse angle relative to the underside 202a of the first cushioned furniture module 202 when the male connector 102 is secured to the underside 202a of the first cushioned furniture module 202. In particular, the tongue 116 includes the first portion 116a which extends substantially perpendicular from the bottom surface 110 of the body 106 and the second portion 116b which extends from and slopes away from the first portion 116a and the bottom surface 110.

The method further includes securing the female connector 104 to the underside 204a of the second cushioned furniture module 204. As described above, the female connector 104 includes the body 118 and the opening 128. The body 118 includes the top surface 120, the bottom surface 122 opposing the top surface 120, the first end 124 and the second end 126 opposing the first end 124. The opening 128 extending through the body 118 from the top surface 122 to the bottom surface 122, the opening 128 is configured as to protrude from underneath the second cushioned furniture module 204. The method further includes inserting the tongue 116 of the male connector 102 into the opening 128 of the female connector 104, compressing the first cushioned furniture module 202 against the second cushioned furniture module 204. In some embodiments, the first portion 116a of the tongue 116 is configured as to slide across the edge of the opening 128 of the body 118 of the female connector 104 when the tongue 116 is inserted into the opening 128 of the body 118 of the female connector 104 as to compress the first cushioned furniture module 202 and the second cushioned furniture module 204. Once inserted, the first portion of the tongue 116a is configured as to sit within the opening 128 of the body 118 of the female connector 104 as to maintain compression of the first cushioned furniture module 202 and the second cushioned furniture module 204.

FIGS. 43 and 44 depict the male connector 102 and the female connector 104 positioned centrally relative to the first cushioned furniture module 202 and the second cushioned furniture module 204, however, this is merely exemplary, and a variety of positions of the male connector 102 and the female 104 relative to the modules 202, 204 is envisioned within the scope of this disclosure.

The various aspects, embodiments, implementations, or features of the described embodiments can be used separately or in any combination. In particular, it should be appreciated that the various elements of concepts from FIGS. 1-44 may be combined without departing from the spirit or scope of the invention.

The subject matter disclosed herein is described here with specificity to meet statutory requirements, but this description is not intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Each example is provided by way of illustration and/or explanation, and not as a limitation.

In the following description, positional terms like “above,” “below,” “vertical,” “horizontal,” “bottom,” “top,” and the like are sometimes used to aid in explaining and specifying features illustrated in the drawings as presented, that is, in the orientation in which labels of the drawings read normally.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated here. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall results as if absolute and total completion were obtained.

Preferred embodiments of this invention are described herein, including the best mode known to the inventors for carrying out the invention. The invention is susceptible to various modifications and alternative constructions, and certain shown exemplary embodiments there are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claim appended hereto as permitted by applicable law. Moreover, any combination of the above-described elements in all possible variations thereof is encompassed by the invention unless otherwise indicted herein or otherwise clearly contradicted by context. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclose. It will be apparent to one of ordinary skill in the art that many modifications and variations are possible in view of the above teachings.

1. A modular furniture system comprising:
a first cushioned furniture module;
a second cushioned furniture;
a first connector configured to be secured to an underside of the first cushioned furniture module, the first connector including:
a body including a top surface, a bottom surface opposing the top surface, a first end, and a second end opposing the first end; and
a tongue positioned at the first end of the body, wherein the first connector is configured to be secured to the underside of the first cushioned furniture module such that at least the tongue of the first connector partially protrudes from underneath the first cushioned furniture module; and
a second connector configured to be secured to an underside of the second cushioned furniture module, the second connector including:
a body including a top surface, a bottom surface opposing the top surface, a first end, and a second end opposing the first end; and
an opening extending through the body from the top surface to the bottom surface, the opening configured to be positioned at the first end of the body, wherein the second connector is configured to be secured to the underside of the second cushioned furniture module such that at least the first end of the body including the opening of the second connector protrudes from underneath the second cushioned furniture module;
wherein the modular furniture system is configured such that inserting the tongue into the opening causes the first cushioned furniture module to compress against the second cushioned furniture module.

2. The system of claim 1, wherein at least a portion of the tongue extends at an obtuse angle relative to the underside of the first cushioned furniture module when the first connector is secured to the underside of the first cushioned furniture module.

3. The system of claim 2, wherein the tongue includes a first portion which extends substantially perpendicular from the bottom surface of the body and a second portion which extends from and slopes away from the first portion and the bottom surface, wherein the second portion extends at the obtuse angle relative to the underside of the first cushioned furniture module.

4. The system of claim 3, wherein the second portion of the tongue is configured as to slide across an edge of the opening of the body of the second connector as to compress the first cushioned furniture module and the second cushioned furniture module.

5. The system of claim 4, wherein the first portion of the tongue is configured as to sit within the opening of the body of the second connector as to maintain compression of the first cushioned furniture module and the second cushioned furniture module.

6. (canceled)

7. (canceled)

8. (canceled)

9. The system of claim 1, wherein only the first and second connectors are used to couple the first module and the second module.

10. The system of claim 1, wherein the first connector further includes a coupling opening extending through the body from the top surface to the bottom surface, the coupling opening configured to accept a fastener.

11. The system of claim 10, wherein the fastener is configured to couple the first connector to the first module.

12. The system of claim 11, wherein the first module further includes an aperture configured to accept the fastener.

13. The system of claim 12, wherein the first module further includes an aperture configured to accept the fastener.

14. The system of claim 1, wherein the second connector further includes a coupling opening extending through the body from the top surface to the bottom surface, the coupling opening configured to accept at least one fastener.

15. The system of claim 14, wherein the at least one fastener is configured to couple the second connector to the second module.

16. The system of claim 1, wherein the first connector further includes a textured surface positioned at the top surface.

17. The system of claim 16, wherein the first connector and the textured surface form a unitary body.

18. The system of claim 1, wherein the second connector further includes a texture surface positioned at the top surface.

19. The system of claim 18, wherein the second connector and the textured surface form a unitary body.

20. An apparatus for coupling a first cushioned furniture module and a second cushioned furniture module comprising:
a first connector configured to be secured to an underside of the first cushioned furniture module including, the first connector including:
a body including a top surface, a bottom surface opposing the top surface, a first end, and a second end opposing the first end; and
a tongue positioned at the first end of the body, wherein the first connector is configured to be secured to the underside of the first cushioned furniture module such that at least the tongue of the first connector partially protrudes from underneath the first cushioned furniture module; and
a second connector configured to be secured to an underside of the second cushioned furniture module, the second connector including:
a body including a top surface, a bottom surface opposing the top surface, a first end, and a second end opposing the first end; and
an opening extending through the body from the top surface to the bottom surface, the opening configured to be positioned at the first end of the body, wherein the second connector is configured to be secured to the underside of the second cushioned furniture module such that at least the first end of the body including the opening of the second connector protrudes from underneath the second cushioned furniture module;
wherein the apparatus is configured such that inserting the tongue into the opening causes the first cushioned furniture module to compress against the second cushioned furniture module.

21. A method for coupling a first cushioned furniture module and a second cushioned furniture module comprising:
securing a first connector to an underside of the first cushioned furniture module, the first connector including:
a body including a top surface, a bottom surface opposing the top surface, a first end, and a second end opposing the first end; and
a tongue positioned at the first end of the body, wherein the first connector is configured to be secured to the underside of the first cushioned furniture module such that at least the tongue of the first connector partially protrudes from underneath the first cushioned furniture module;
securing a second connector to an underside of the second cushioned furniture module, the second connector including:
a body including a top surface, a bottom surface opposing the top surface, a first end, and a second end opposing the first end; and
an opening extending through the body from the top surface to the bottom surface, the opening configured to be positioned at the first end of the body, wherein the second connector is configured to be secured to the underside of the second cushioned furniture module such that at least the first end of the body including the opening of the second connector protrudes from underneath the second cushioned furniture module; and
inserting the tongue of the first connector into the opening of the second connector, compressing the first cushioned furniture module against the second cushioned furniture module.

22. The method of claim 21, wherein at least a portion of the tongue extends at an obtuse angle relative to the underside of the first cushioned furniture module when the first connector is secured to the underside of the first cushioned furniture module.

23. The method of claim 22, wherein the tongue includes a first portion which extends substantially perpendicular from the bottom surface of the body and a second portion which extends from and slopes away from the first portion and the bottom surface, wherein the second portion extends at the obtuse angle relative to the underside of the first cushioned furniture module.

24. The method of claim 23, wherein the first portion of the tongue is configured as to slide across an edge of the opening of the body of the second connector when the tongue is inserted into the opening of the body of the second connector as to compress the first cushioned furniture module and the second cushioned furniture module.

25. The method of claim 24, wherein after inserting the tongue of the second connector into the opening of the second connector, the first portion of the tongue is configured as to sit within the opening of the body of the second connector as to maintain compression of the first cushioned furniture module and the second cushioned furniture module.
